(19) United States
(12) Patent Application Publication
(10) Pub. No.: US 2011/0304599 A1
(43) Pub. Date: Dec. 15, 2011

(54) LED Driving Device and Display Apparatus

(75) Inventor: Hidenori Yasui, Kanagawa (JP)

(73) Assignee: Kabushiki Kaisha Toshiba, Tokyo (JP)

(21) Appl. No.: 13/052,259

(22) Filed: Mar. 21, 2011

(30) Foreign Application Priority Data
Jun. 14, 2010 (JP) 2010-135529

(51) Int. Cl. G09G 3/36; G06F 3/038; H05B 37/02

(52) U.S. Cl. 345/207; 315/152; 345/102

(57) ABSTRACT

An embodiment of the present invention includes an LED driving device that causes a plurality of LEDs to emit light, wherein the device includes: an LED driving circuit configured to drive the LEDs so that at least one of the plurality of LEDs emits light as a first. LED and an LED around the first LED is prevented from emitting light as a second LED; a photodetection unit configured to detect light emission of the first LED through the second LED and detect a light emission quantity of the first LED; and a controller configured to adjust a light emission quantity of the first LED based on the light emission quantity of the light emission of the first LED detected by the photodetection unit.

### CROSS REFERENCE TO RELATED APPLICATION

This application is based upon and claims the benefit of priority from Japanese Patent Application No. 2010-135529 filed in Japan on Jun. 14, 2010; the entire contents of which are incorporated herein by reference.

### FIELD

Embodiments described herein relate generally to an LED driving device and a display apparatus that prevent brightness variation among LEDs.

### BACKGROUND

Conventional backlight devices using light-emitting diodes (hereinafter referred to as LEDs), due to brightness variation among the LEDs, suffer brightness variation even with a current value kept constant. Therefore, as means for preventing such variation among the LEDs, brightness screening is performed before product assembly, or feedback control is performed based on the result of detection by a dedicated photodetector such as a photodiode at the time of driving the LEDs, so as to prevent the brightness variation among the LEDs.

### BRIEF DESCRIPTION OF THE DRAWINGS

FIG. 1 is a block diagram showing an LED driving device in a first embodiment of the present invention;

FIG. 2 is a block diagram showing an LED driving device in a second embodiment of the present invention;

FIG. 3 is a diagram illustrating exemplary operation of the LED driving device in the second embodiment;

FIG. 4 is a block diagram showing an LED driving device in a third embodiment of the present invention;

FIG. 5 is a block diagram showing an LED driving device in a fourth embodiment of the present invention;

FIG. 6 is a block diagram showing an LED driving device in a fifth embodiment of the present invention;

FIG. 7 is a diagram illustrating exemplary operation of the LED driving device in the fifth embodiment; and

FIG. 8 is a plan view showing an exemplary arrangement of an LED driving device used for a backlight device in a liquid crystal display apparatus.

### DETAILED DESCRIPTION

Embodiments of the present invention include an LED driving device that drives a plurality of LEDs, wherein the device includes an LED driving circuit, a photodetection unit, and a controller.

The LED driving circuit can drive at least one first LED to emit light and at lease one second LED not to emit light.

The photodetection unit can detect light emission quantity of the first LED by using the second LED.

The controller can adjust a light emission quantity of the first LED based on the light emission quantity of the first LED.

### First Embodiment

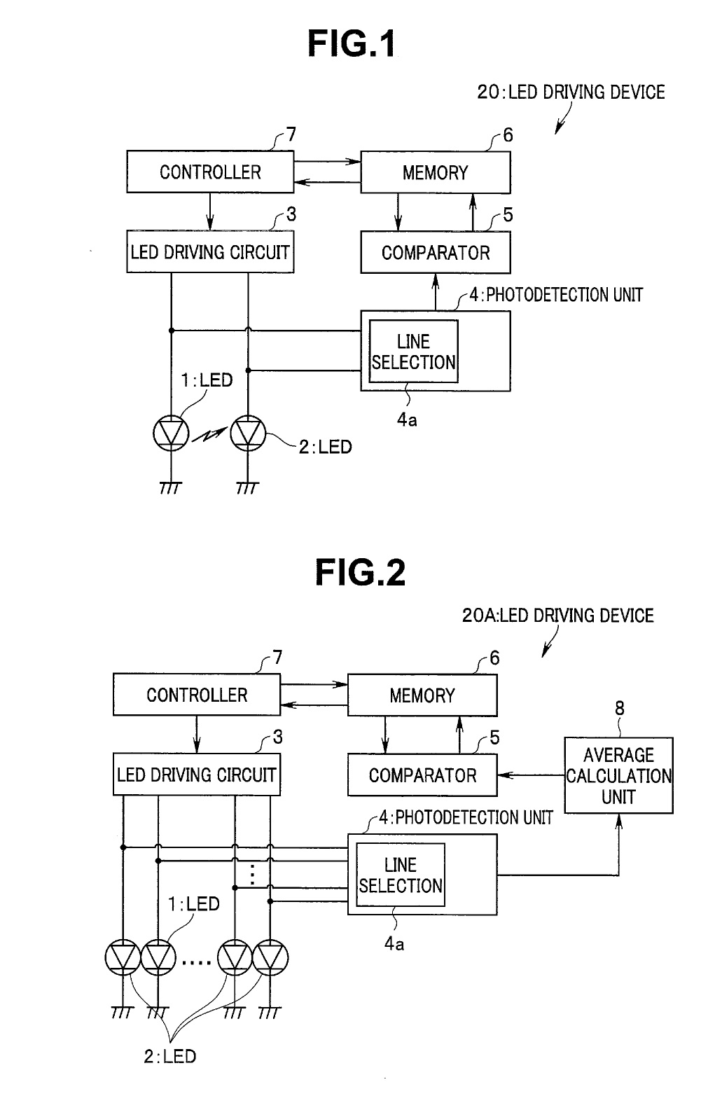

FIG. 1 shows a block diagram of an LED driving device in a first embodiment of the present invention.

In FIG. 1, an LED driving device 20 includes: two LEDs 1 and 2; an LED driving circuit 3 configured to drive the two LEDs 1 and 2; a photodetection unit 4 configured to use, for measuring a light emission quantity, one of the two LEDs 1 and 2 that is not a light-emitting first LED; a comparator 5; a memory 6 as a storage unit; and a controller 7 as a control unit. The configuration below will be described assuming that the LEDs 1 and 2 used are white light-emitting diodes.

The LED driving device 20 has at least: a function of causing a plurality of (two in FIG. 1) LEDs 1 and 2 to emit light and obtaining light source; and a function of individually causing the LEDs 1 and 2 to emit light to detect a light emission quantity of one light-emitting LED through the other non-light-emitting LED, and comparing the detection result with reference data to obtain a light emission quantity correction value for correcting light emission quantity variation of each of the LEDs land 2.

When the LED 1, one of the LEDs 1 and 2, is caused to emit light as a first LED, the photodetection unit 4 detects data that reflects the quantity of light emitted by the first LED 1. The LED 2, the other one of the LEDs 1 and 2, located around the first LED 1 is used as a light emission quantity second LED (i.e., a photoreception element). Conversely, when the LED 2 out of the LEDs 1 and 2 is caused to emit light as a first LED, the other LED 1 located around the LED 2 is used as a light emission quantity second LED (a photoreception element). Accordingly, when the other LED 2 out of the LEDs 1 and 2 is caused to emit light as a first LED, the photodetection unit 4 detects data that reflects the quantity of light emitted by the one first LED 2.

The following description takes, as an example, a case where the one first LED caused to emit light is the LED 1.

In this case, the LED driving circuit 3 drives the one first LED 1 out of the LEDs 1 and 2 to emit light and refrains from driving the other LED 2 to emit light. This light emission driving is controlled under instructions from the controller 7.

The memory 6 stores the reference data serving as a reference quantity of light emitted by a single LED. The memory 6 also stores the light emission quantity correction value for each of the LEDs obtained by the light emission quantity detection.

The comparator 5 compares the reference data stored in the memory 6 with light emission quantity data on the one first LED 1 detected by the photodetection unit 4 that detects an electromotive voltage generated in the LED 2. The comparator 5 outputs the comparison result to the memory 6 to be stored therein as the light emission quantity correction value for the first LED 1. When the other LED 2 is driven to emit light as a first LED and the light emission quantity of the LED 2 is detected through the LED 1 serving as a light emission quantity second LED, the reference data is compared with light emission quantity detection data on the LED 2 based on an electromotive voltage in the LED 1. The comparison result is then stored in the memory 6 as the light emission quantity correction value for the LED 2. Thus, once the LEDs 1 and 2 have been individually caused to emit light to detect the light emission quantity and the light emission quantity correction value has been obtained for each of the LEDs 1 and 2, the memory 6 has the light emission quantity correction value for each LED stored therein.

The photodetection unit 4 is provided with a light emission quantity detection line selection circuit 4a. Connected to the light emission quantity detection line selection circuit 4a as an input thereto is an output line from each anode of the LEDs 1 and 2, including the one light-emitting first LED 1 and at least one other light emission quantity second LED 2 around the LED 1. Only the light emission quantity detection line of the light emission quantity second LED 2 other than the one light-emitting first LED 1 can be selected for the light emission quantity detection, while the output line from the first LED 1 to the photodetection unit 4 can be electrically disconnected. This operation is implemented as follows. The photodetection unit 4 detects whether or not a voltage generated at the output line of each of the LEDs 1 and 2 is equal to or higher than a threshold. The output line with a voltage equal to or higher than the threshold, to which a light emission driving voltage is being supplied, is regarded as a light emission driving line and disconnected. The output line with a voltage lower than the threshold, to which the light emission driving voltage is not being supplied, is regarded as a light emission quantity detection line and selected to be connected.

When all or part of the LEDs 1 and 2 are used as light source, the LED driving circuit 3 drives the light emission of the LEDs 1 and 2 by individually varying the light emission quantities of the LEDs 1 and 2 according to the light emission quantity correction value for each LED stored in the memory 6 so that a constant reference light emission quantity is achieved.

The controller 7 sets the reference data for the light emission of the LEDs in the memory 6. The controller 7 also controls driving of the LED driving circuit 3 at the time of measuring the light emission quantity with respect to which of the LEDs is to be caused to emit light as a first LED. When the LEDs are used as light sources for illumination, the controller 7 reads the light emission quantity correction value for each LED stored in the memory 6 and supplies a control signal for brightness correction to the LED driving circuit 3 in order to control the brightness of each LED based on the light emission quantity correction value.

If the LEDs include three or more LEDs, one of the LEDs is a first LED and the remaining two or more LEDs are used as light emission quantity second LEDs. Such cases will be described in second and subsequent embodiments.

The above configuration will be more specifically described below.

The LED driving circuit 3 can cause the two LEDs 1 and 2 to emit light (to be turned on) by supplying a driving current between an anode and a cathode of each of the LEDs based on a driving voltage, and to stop emitting light (to be turned off) by stopping supplying the driving current.

The anode of each of the LEDs 1 and 2 is connectable to the LED driving circuit 3 and also to the photodetection unit 4. Under instructions from the controller 7, when the LED driving circuit 3 detects the light emission quantity of one of the two LEDs 1 and 2 (e.g., the LED 1) to measure the light emission quantity correction value, the LED driving circuit 3 controls to supply the driving current to the LED 1 to cause the LED 1 to emit light (to be turned on) while not to supply the driving current to the other LED (e.g., the LED 2). Conversely, under instructions from the controller 7, when the LED driving circuit 3 detects the light emission quantity of the LED 2 out of the two LEDs 1 and 2 to measure the light emission quantity correction value, the LED driving circuit 3 controls to supply the driving current to the LED 2 to cause the LED 2 to emit light (to be turned on) while not to supply the driving current to the other LED 1.

A high voltage corresponding to the driving current is generated at the anode of the light-emitting LED (e.g., the LED 1) out of the anodes of the LEDs 1 and 2. On the other hand, an electromotive voltage due to the photoelectric effect is generated at the anode of the LED (e.g., the LED 2) not driven to emit light but used for measuring the light emission quantity.

Thus, a relatively large voltage difference exists between the voltage generated at the anode of the light-emitting LED 1 and the voltage generated at the anode of the non-light-emitting LED 2. Therefore, this voltage difference, or the fact that the LED 1 is driven to emit light, is utilized to detect the light emission quantity of the LED 1 with a larger anode voltage and to measure the light emission quantity correction value for the LED 1. At this point, only the electromotive voltage output to the light emission quantity detection line at the anode of the LED 2 is input to the photodetection unit 4, while the light emission quantity detection line of the LED 1 is disconnected so that the driving voltage output thereto is not input to the photodetection unit 4.

For this purpose, the light emission quantity detection line selection circuit 4a is provided in the photodetection unit 4. This allows selecting the detection line connected to the anode of one of the two LED 1 and 2 that is used for measuring the light emission quantity, while disconnecting the detection line connected to the anode of the light-emitting first LED.

The above configuration of the present embodiment utilizes the fact that, due to the photoelectric effect of LEDs, the reception of light causes voltage to be generated at the anode terminal serving as an output terminal. When the first LED 1 is emitting light, voltage that reflects the light emission brightness is generated in the light emission quantity second LED 2 and detected with the photodetection unit 4. Conversely, when the LED 2 is emitting light, the LED 1 is used for measuring the light emission quantity, as described above.

The degree of the detected voltage can be measured by comparison with a reference voltage stored in the memory 6. The comparison yields the difference between the detected voltage and the reference voltage, which is then stored for each LED in the memory 6 as the light emission quantity correction value. After the light emission quantity correction values are measured for all the LEDs and when the LEDs 1 and 2 are caused to emit light (to be turned on) as light source, the controller 7 reads the light emission quantity correction value for each LED stored in the memory 6. The controller 7 controls the LED driving circuit 3 to increase or decrease the driving current for each of the LEDs 1 and 2. Thus, uniform light source without variation among the LEDs can be achieved.

According to the first embodiment, light emission quantities of LEDs emitting light can be adjusted based on data that reflects the light emission quantities from the photodetection unit. Therefore, a constant light emission quantity can be achieved even if the individual LEDs vary in light emission quantity, so that inexpensive LEDs not subjected to brightness screening can be used.

One of a plurality of LEDs is taken as a first LED, and an LED around the first LED is used as a photoreception element for measuring the light emission quantity. This eliminates the need to specially provide a dedicated photodetection element and allows an inexpensive LED driving device to be configured.

### Second Embodiment

FIG. 2 shows a block diagram of an LED driving device in a second embodiment of the present invention.

Unlike the first embodiment, in the second embodiment, more than one light emission quantity second LED 2 is used as part of the photodetection unit 4 as shown in FIG. 2. An average calculation unit 8 is additionally provided for calculating an average of light emission quantity detection values based on photoelectric outputs from the light emission quantity second LEDs 2.

That is, the second embodiment illustrates a case where there are a plurality of light emission quantity second LEDs 2 as well as one light-emitting first LED 1.

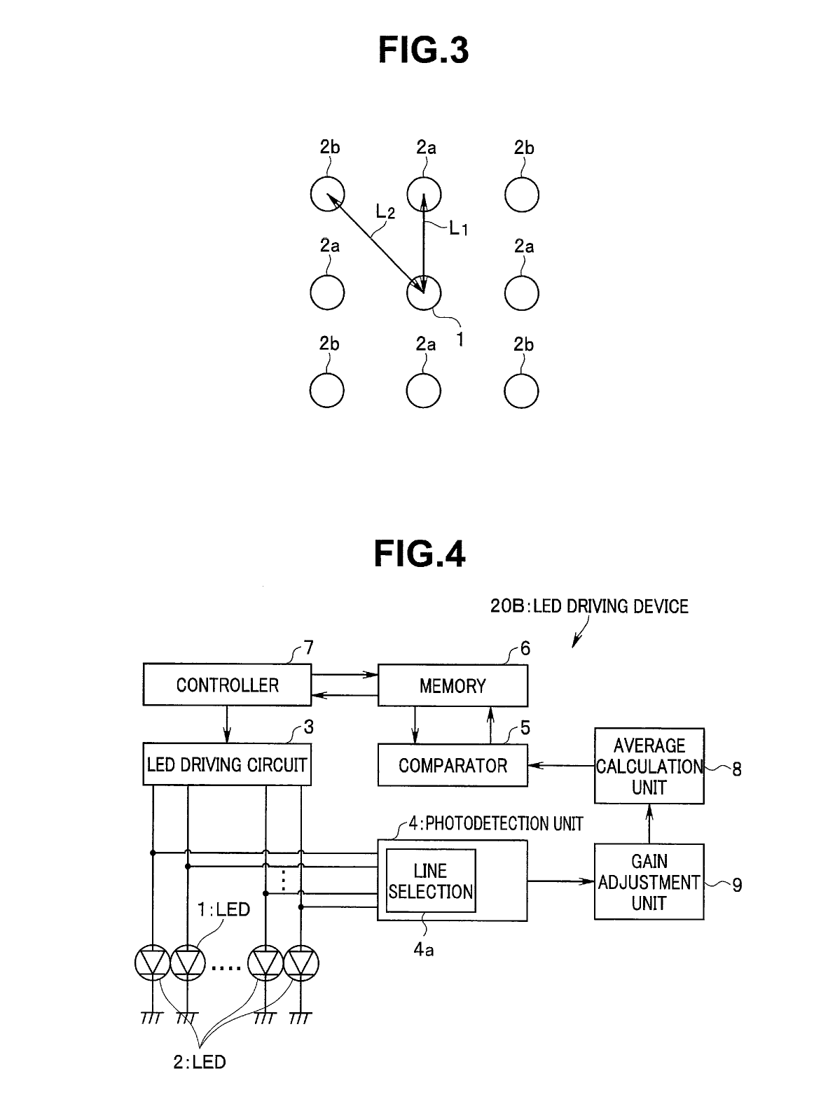

Consider a planar LED light source device (e.g., a backlight device in a liquid crystal display apparatus) on which LEDs are arranged as a matrix of rows and columns. For example, an LED driving device is implemented that is capable of preventing LED brightness variation for a matrix of 3×3 LEDs as shown in FIG. 3. In this case, around one first LED 1, a plurality of (e.g., eight) other light emission quantity second LEDs 2 (denoted by 2a and 2b in FIG. 3) can be set. “◯” represents an LED. However, if the eight LEDs around the one first LED 1 are used as light emission quantity second LEDs as in FIG. 3, a difference in distance from the first LED 1 exists between a set of the four LEDs 2a on the top, bottom, left, and right, and a set of the other diagonal four LEDs 2b. Compensating for this distance difference will be described in a next third embodiment.

Therefore, in the second embodiment, it is preferable to use, as light emission quantity second LEDs, either the four LEDs 2a on the top, bottom, left, and right shown in FIG. 3, or the four LEDs 2b on the upper right, lower left, upper left, and lower right shown in FIG. 3, which are equidistant from the one first LED 1, respectively.

As in FIG. 1, light emission quantity detection lines of the LEDs, including the one light-emitting first LED 1 and the other light emission quantity second LEDs 2 around the first LED 1, are connected to the photodetection unit 4, and the light emission quantity detection line selection circuit 4a is provided for disconnecting the light emission quantity detection line of the one light-emitting first LED 1 and for selecting the light emission quantity detection lines of the other light emission quantity second LEDs 2. However, in the second embodiment in FIG. 2, a plurality of light emission quantity detection signals from the plurality of LEDs 2 is obtained. From the plurality of detected voltages, the additionally provided average calculation unit 8 calculates an average voltage per LED 1 and outputs the average voltage to the comparator 5.

As described above, in the second embodiment illustrated in FIG. 2, the LEDs 2 in the proximity of and equidistant from the light-emitting LED 1 are used as photoreception elements.

A device such as an LED backlight device for television employed in a display of a liquid crystal display apparatus uses many LEDs. Therefore, in measuring the light emission quantity, a plurality of LEDs exist in the proximity of one light-emitting first LED. These LEDs are used as photoreception elements for measuring the light emission quantity to take an average of the detected light emission quantity data. In this manner, variation in photoelectric effect among the LEDs operated as the photoreception elements can be averaged to allow the LEDs to function as more accurate light emission quantity detectors.

According to the second embodiment, when light emission quantities of LEDs are individually measured in an LED driving device for illumination in which a plurality of LEDs are arranged, a plurality of LEDs around a first LED are used as photoreception elements to take an average of detected values. Thus, the influence of variation among the LEDs as the photoreception elements can be reduced to allow more accurate light emission quantity detection.

### Third Embodiment

FIG. 4 shows a block diagram of an LED driving device in a third embodiment of the present invention.

In the light emission quantity detection through a plurality of light emission quantity second LEDs illustrated in the second embodiment in FIG. 2, the distance from the light-emitting first LED may vary with the light emission quantity second LEDs. For example, in FIG. 3, the eight LEDs 2 around the one first LED 1 include two sets: the set of the four LEDs 2a all at the same distance L1 from the LED 1, and the set of the four LEDs 2b all at the same distance L2 (L2>L1) from the LED 1. In such a case, in the third embodiment, levels of detection outputs from the photodetection unit 4 based on the light emission quantity detection through the light emission quantity second LEDs 2 are adjusted between the set of the LEDs 2a and the set of the LEDs 2b according to the distances, so that the difference in detection level due to the distances is compensated for. In this manner, the varying distances between the light emission quantity second LEDs 2 and the light-emitting first LED 1 can be addressed.

In the third embodiment, a gain adjustment circuit 9 is further provided. If a plurality of light emission quantity second LEDs 2 are used as photoreception elements, and if these light emission quantity second LEDs 2 are at varying distances from one light-emitting first LED 1, the gain adjustment circuit 9 corrects detection outputs of, e.g., the farther light emission quantity second LEDs 2b among detection outputs of the light emission quantity second LEDs 2 depending on the distance. The detection outputs are therefore converted into detection outputs for the same distance as the closer light emission quantity second LEDs 2a. For this purpose, the gain adjustment circuit 9 adjusts amplitude levels of the detection outputs of the light emission quantity second LEDs 2.

Also in the third embodiment, as described above, light emission quantity detection lines of the LEDs, including the one light-emitting first LED and the light emission quantity second LEDs around the first LED, are connected to the photodetection unit 4, and the light emission quantity detection line selection circuit 4a is provided for selecting the light emission quantity detection lines of the surrounding light emission quantity second LEDs other than the one light-emitting first LED.

Even if the plurality of light emission quantity second LEDs around the one light-emitting first LED are each located at a different distance from the one first LED, the light emission quantity detection values are corrected according to the distance differences and then added up to calculate an average. That is, the average is calculated after the gain adjustment circuit corrects the light emission quantity detection outputs to compensate for the differences due to the distances.

The number of LEDs is not limited to nine in total, i.e., one first LED 1 and eight light emission quantity second LEDs 2 around the first LED 1, but many more LEDs may be arranged around the periphery. However, with nine or more light emission quantity second LEDs 2 around the one first LED 1, using nine or more LEDs 2 for measuring the light emission quantity results in that the ninth and subsequent LEDs are located farther in a typical grid arrangement. Therefore, the influence of the photoreception quantity errors due to the distance differences is increased in measuring the light emission quantity of the first LED 1 at the center, making the correction of the errors more complicated. It is nevertheless possible to convert the light emission quantity detection values into values for the same distance in a manner similar to the third embodiment.

According to the third embodiment, even if a plurality of light emission quantity second LEDs around one light-emitting first LED are each located at a different distance from the one first LED, detected values of the light emission quantity second LEDs can be converted into light emission quantities for LEDs all at the same distance from the light-emitting LED. Thus, the case where the light emission quantity second LEDs are at varying distances from the first LED can be addressed.

### Fourth Embodiment

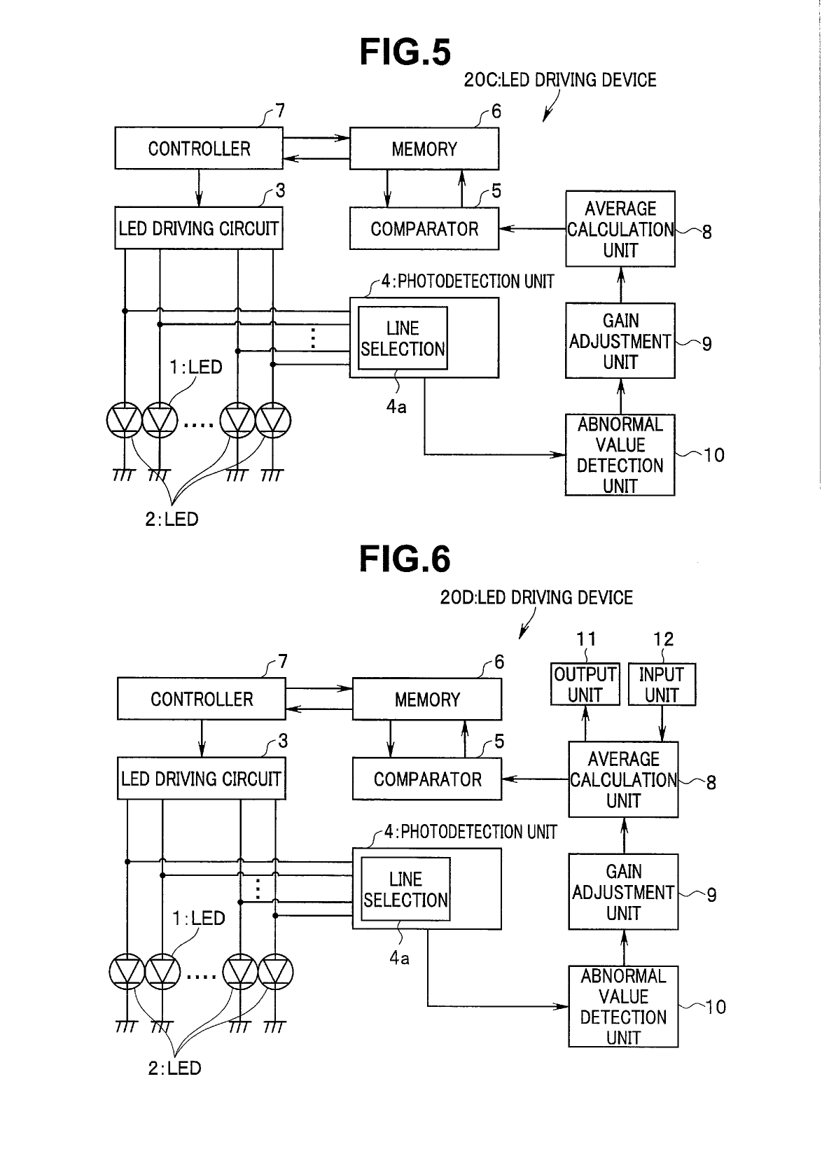

FIG. 5 shows a block diagram of an LED driving device in a fourth embodiment of the present invention.

When LEDs suffer deterioration (including a short circuit or a broken wire) due to a cause such as aging, an abnormal voltage value may be detected in a light emission quantity second LED, resulting in an excessively large light emission quantity correction value. This leads to an unusual situation where an LED is extremely bright when lit as light source. To prevent this, in the fourth embodiment, an abnormal value detection unit 10 is provided for detecting an abnormal value in the detected voltages from photodetection unit 4. If there is a possibility of the presence of a short circuit or a broken wire in the light emission quantity second LEDs, a relevant detected voltage can be excluded to calculate the brightness (the light emission quantity). The abnormal value detection unit 10 may also be used for the LED driving devices illustrated in the first to third embodiments in FIGS. 1, 2, and 4.

That is, where at least one other light emission quantity second LED 2 is used as a photoreception element, the abnormal value detection unit 10 is further provided for determining whether the output of the at least one other LED 2 is normal.

In the above-described fourth embodiment, when there are a plurality of light emission quantity second LEDs for one first LEDs and if any of a plurality of obtained light emission quantity detection values is found abnormal, the abnormal value detection unit 10 excludes the abnormal value. The gain adjustment unit 9 then performs gain adjustment, and the average calculation unit 8 further calculates an average of the detected voltages.

According to the fourth embodiment, the abnormality detection by the abnormal value detection unit 10 is applied to the detection outputs from the photodetection unit 4. Then, in the presence of deterioration (including a short circuit or a broken wire) due to a cause such as aging of LEDs, photodetection data on a deteriorated LED can be excluded. Therefore, the light emission quantity correction values can be calculated based on only proper data, so that a constant light emission quantity corresponding to the reference data can be maintained when the LEDs are used for illumination. Further, since the abnormal value detection unit is added, not only when adjustment is performed at the time of manufacture but also when an LED failure occurs such as during the use after manufacture, the correction of brightness variation is performed to find and address the failure. Thus, the light emission quantities of the LEDs are readjusted without causing significant problems.

### Fifth Embodiment

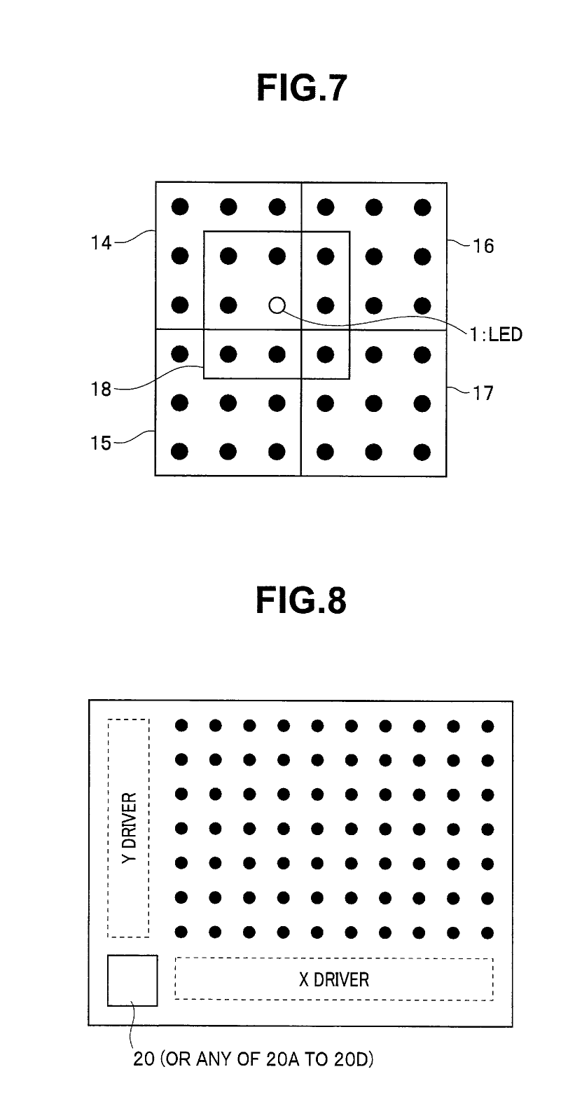

FIG. 6 shows a block diagram of an LED driving device in a fifth embodiment of the present invention. FIG. 7 shows an illustrative diagram of exemplary operation in FIG. 6.

In an LED driving device in an apparatus such as a liquid crystal display apparatus for television, it is difficult to measure light emission quantities of many LEDs corresponding to the size of the entire television screen at a time. Therefore, actually, control is often performed by dividing one screen into several blocks as shown in FIG. 7. FIG. 7 shows four 3×3 blocks 14 to 17. A white dot “◯” represents a first LED that emits light in the light emission quantity measurement, and a black dot “” represents an LED that stops emitting light in the light emission quantity measurement. “” within a solid-line frame 18 are LEDs that function as light emission quantity second LEDs. However, when the screen is divided into blocks as shown in FIG. 7, the light of one first LED ranges not only within a predetermined one block but to several adjacent blocks.

For example, depending on the position of the one first LED 1 in the one block 14, the eight light emission quantity second LEDs (corresponding to “” in the solid-line frame 18) around the first LED 1 exist not only within the block 14 in which the first LED 1 is located, but extend to corresponding positions in the other adjacent blocks 15 to 17. In this case, without consideration of exchanging the light emission quantity detection values with the adjacent blocks, the light emission quantity detection value for the first LED 1 cannot be accurately calculated.

Therefore, in addition to the configuration of the fourth embodiment in FIG. 5, the LED driving device 20D in the fifth embodiment shown in FIG. 6 includes an output unit 11 configured to output detection values to other blocks, and an input unit 12 configured to receive detection values from other blocks.

Consider the case in FIG. 7 where the backlight device for the entire screen includes 36 LEDs (6×6=36), for example. Nine LEDs (3×3=9) denoted by numeral 14 forms one block, and one screen consists of the four blocks 14 to 17. The white dot “◯” in the upper-left block 14 out of the four blocks 14 to 17 represents the one light-emitting first LED 1, and the eight LEDs around the first LED 1 serves as photoreception elements for measuring the light emission quantity. Therefore, as indicated by the solid-line frame 18 in FIG. 7, these nine LEDs exist across the four blocks. Then, outputs of the eight photoreception elements for detecting the quantity of light emitted from the one light-emitting first LED 1 must be taken from the four blocks 14 to 17. It is to be noted that the LED driving device 20D shown in FIG. 6 represents one circuit configuration required for each block. Therefore, actually, for example in a television receiving display, the same number of LED driving devices as blocks forming a television screen exist. However, the controller 7 and the memory 6 may be commonly used (shared) among a certain number of blocks or among all the blocks forming the screen.

In measuring the light emission quantity variation, the apparatus operates as follows. Since it is known which LED in which block is emitting light (turned on) in the screen, LEDs to be used for photoreception around the light-emitting LED can be known from the position of the light-emitting LED. In the example of FIG. 7, it can be known which of the four blocks 14 to 17 contain light emission quantity second LEDs, and whether one such LED is or two such LEDs are receiving light in each block. Therefore, for example, light emission quantity data of one LED is taken from another diagonal first block 17, light emission quantity data of two LEDs is taken from another adjacent second block 15, and light emission quantity data of two LEDs is taken from another adjacent third block 16. Further, light emission quantity data of three LEDs is gathered from the block 14 itself containing the light-emitting LED 1. Then, the average light emission quantity is calculated. The average is compared with the reference value in the comparator 5, and the difference from the reference value is stored as the light emission quantity correction value in the memory 6. The operation for obtaining the correction value for the light emission quantity variation is thus finished.

Thus, since the number of output lines of the LED driving circuit 3 is typically limited, the screen is divided into several blocks as in FIG. 7 and the entire screen cannot be controlled with one circuit. In this case, by providing the output unit 11 configured to output detection values to other blocks and the input unit 12 configured to receive inputs of detection values from other blocks, the average can be calculated without problems even if the second LEDs exist across several blocks.

According to the fifth embodiment, an apparatus, such as a backlight device, in which LEDs are two-dimensionally arranged to obtain light source may be configured. In this case, the LED driving device for illumination provides for a uniform light emission quantity of the LEDs that two-dimensionally emit light. The LED driving device also drives the light emission by dividing the range of light source emission corresponding to the entire screen into a plurality of blocks. In this LED driving device, the average of the light emission quantities can be calculated without problems even if the light emission quantity second LEDs exist across several blocks. Therefore, the light emission quantity variation of all the LEDs used for the backlight light source can be individually calculated without the need to provide a special dedicated photodetection element.

FIG. 8 shows an example of an array of LEDs and an arrangement of the LED driving device (20, 20A, 20B, or 20D) illustrated in the first to fifth embodiments that drives the light emission of these LEDs, in a backlight device of a display for a liquid crystal display apparatus. That is, FIG. 8 shows a plan view of a backlight device that uses a plurality of LEDs (represented as black dots), the light emission of which is driven by the LED driving device. The backlight device is disposed on the back of the liquid crystal display (not shown).

Although the present embodiments take a liquid crystal display apparatus as an example, the present embodiments are applicable to any LED-driven display apparatuses.

According to the above-described embodiments of the present invention, an LED driving device capable of preventing brightness variation can be implemented without performing brightness screening before product assembly and without the need to provide a special dedicated photodetection element as a photodetector.

In the above embodiments, the LED driving devices that use white LEDs have been described. However, for color LEDs where R, G, and B are used as light sources, the light emission efficiency varies among R, G, and B. In this case, different reference values may be set for R, G, and B, respectively. Thus, the embodiments of the present invention may be adapted to the correction of brightness variation among LEDs of different colors.

While certain embodiments have been described, these embodiments have been presented by way of example only, and are not intended to limit the scope of the inventions. Indeed, the novel systems described herein may be embodied in a variety of other forms; furthermore, various omissions, substitutions and changes in the form of the systems described herein may be made without departing from the spirit of the inventions. The accompanying claims and their equivalents are intended to cover such forms or modifications as would fail within the scope and spirit of the inventions.

What is claimed is:

1. An LED driving device that drives'a plurality of LEDs, comprising:
an LED driving circuit configured to drive at least one first LED to emit light and at least one second LED not to emit light;
a photodetection unit configured to detect light emission quantity of the first LED by using the second LED; and
a controller configured to adjust a light emission quantity of the first LED based on the detected light emission quantity of the first LED.

2. The LED driving device according to claim 1, wherein the second LED detects light emission quantity of the first LED by a photoelectric effect.

3. The LED driving device according to claim 1, further comprising a comparison unit configured to calculate a correction value for the light emission quantity of the first LED based on a comparison result of comparing the detected light emission quantity of the first LED with a reference value.

4. The LED driving device according to claim 1, wherein the photodetection unit detects the light emission quantity of the first LED by using a plurality of the second LEDs, and the controller adjusts the light emission quantity of the first LED based on an average value of detected light emission quantity of the first LED.

5. The LED driving device according to claim 3, further comprising a memory configured to store the correction value of each LED, wherein when the plurality of LEDs are used as light source, the light emission quantity of the LEDs is individually adjusted based on the correction value for each LED stored in the memory.

6. The LED driving device according to claim 3, wherein the LED driving device further comprises a gain adjustment circuit, the gain adjustment circuit performing compensation for the correction value based on a distance from the first LED to each of the plurality of second LEDs in a case when detecting light emission quantity of the first LED by using a plurality of second LEDs.

7. The LED driving device according to claim 1, further comprising an abnormal value detection unit for determining whether the detected light emission quantity of the first LED is normal.

8. The LED driving device according to claim 1, wherein output lines of a plurality of LEDs including the first LED and at least one second LED around the first LED are connected to the photodetection unit, and a light emission quantity detection line selection circuit is provided in the photodetection unit for selecting at least one necessary light emission quantity detection line of the second LED among the output lines of the plurality of LEDs.

9. The LED driving device according to claim 1, wherein when the LED driving device is configured to drive LEDs with a block unit, each block unit including a plurality of LEDs, the LED driving circuit used for each block comprises an input unit configured to receive a light emission quantity detection value from another block and an output unit configured to output a light emission quantity detection value to be supplied to another block if a range of the light emission of the first LED in one block extends to adjacent blocks at a time of light emission quantity detection for each LED.

10. The LED driving device according to claim 8, wherein the light emission quantity detection line selection circuit detects whether or not a voltage generated at each output line of each of the plurality of LEDs connected to the photodetection unit is equal to or higher than a threshold, and disconnects, as a light emission driving line, the output line with a voltage equal to or higher than the threshold to which a light emission driving voltage is supplied, and selects and connects, as the light emission quantity detection line, the output line with a voltage lower than the threshold to which the light emission driving voltage is not supplied.

11. A liquid crystal display apparatus with an LED driving device that a plurality of LEDs, the apparatus comprising:
the LED driving device comprising
an LED driving circuit configured to drive at least one first LED to emit light and at least one second LED not to emit light,
a photodetection unit configured to detect light emission quantity of the first LED by using the second LED, and
a controller configured to adjust a light emission quantity of the first LED based on the detected light emission quantity of the light emission of the first LED; and
a display comprising a backlight device that uses the plurality of LEDs, the light emission of which is driven by the LED driving device.
